(19) United States
(12) Patent Application Publication
(10) Pub. No.: US 2010/0033964 A1
(43) Pub. Date: Feb. 11, 2010

(54) LIGHT EMITTING DIODE (LED) LIGHTING DEVICE

(75) Inventors: Sui Cheung CHOI, Fanling (CN); Yat Sun Chan, Shatin (CN)

Correspondence Address: EGBERT LAW OFFICES, 412 MAIN STREET, 7TH FLOOR, HOUSTON, TX, 77002, US

(73) Assignee: Photonics & Co., Limited, Hong Kong (HK)

(21) Appl. No.: 12/188,824

(22) Filed: Aug. 8, 2008

(51) Int. Cl. F21V 33/00; B60Q 1/00

(52) U.S. Cl. 362/234; 362/227

(57) ABSTRACT

The present invention is an alternative lighting technology to form light emitting diode (LED) light tube. The tubular or circular LED tube is formed by transparent plastic and a metal heat sink that includes LEDs soldered onto a metal core printed circuit board with a special arrangement to achieve greater brightness than an equal distance arrangement. All LEDs are directly inserted into the metal core printed circuit board with a unique insulation coating to allow the LED anode and cathode to be inserted into the metal core printed circuit board and soldered on the opposite side of the metal core printed circuit board. It can connect one or more control units to control intensity.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to light emitting diode (LED) lighting devices.

2. Description of Related Art Including Information Disclosed Under 37 CFR 1.97 and 37 CFR 1.98.

From this present moment, fluorescent is one of the most commonly used types of general lighting. It works under AV Voltage from 100 VAC to 245 VAC depending upon the particular country. Compared to incandescent bulbs, fluorescent is quite energy efficient; however the life time of the fluorescent device is typically around 10000 hrs. Fluorescent contains mercury, and it needs to be properly disposed of to prevent pollution to the environment.

In the recent years, technology has moved fast on LED development. It is already as efficient as sub pass fluorescent, and now new LEDs can be use as an alternative light source for general lighting. The most important quality of the LED is that the LED is 100% green to the environment.

The only disadvantage to LED is the heat generated when switched on. In the most efficient light source, energy converts into light and heat. The LED is already one of the most efficient to convert electrical energy into light; however the LED still produces heat. The only problem is that LED does not radiate the generated heat; it only transfers the heat through conduction to the frame of the LED. If there is no good thermal management to take care of the heat generated by the LED, then the life of the LED will be shortened very rapidly.

As world economies consume energy, global warming has increased more quickly than expected. To develop a high energy saving and 100% green, and truly long lasting lighting is necessary.

### BRIEF SUMMARY OF THE INVENTION

In this invention the LED lighting device is tubular or circular. The lighting device can be installed on any kind of T8, T12 Fixtures or without the fixture. The lighting device is truly long lasting and 100% green to the environment.

### BRIEF DESCRIPTION OF THE SEVERAL VIEWS OF THE DRAWINGS

FIG. 1 is a schematic view of the present invention.

FIG. 2 is a top plan view of the special insertion type aluminum printed circuit board (PCB) layout.

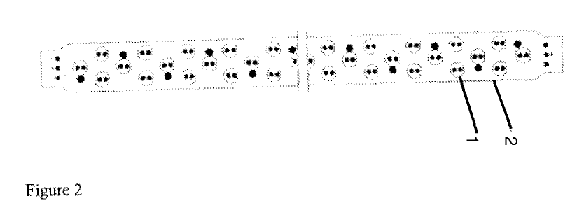

FIG. 3 is an exploded perspective view of the present invention with the LEDs.

FIG. 4 is a schematic view of the electrical circuit diagram to connect from the AC source to the LED driver, then from the LED driver to the LED circular light tube.

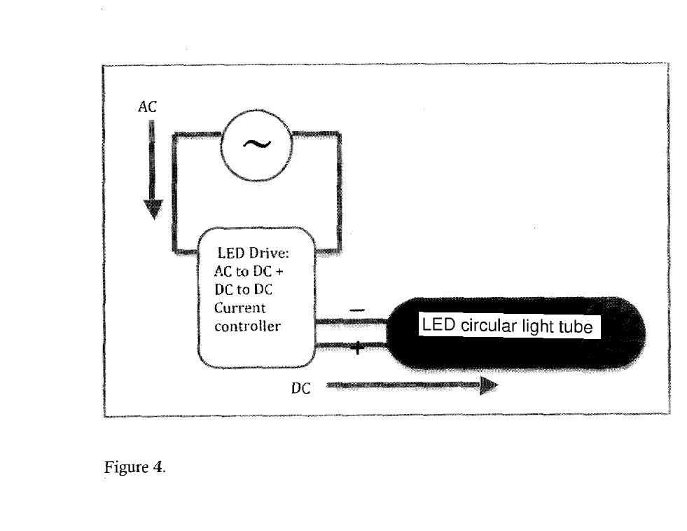

### DETAILED DESCRIPTION OF THE INVENTION

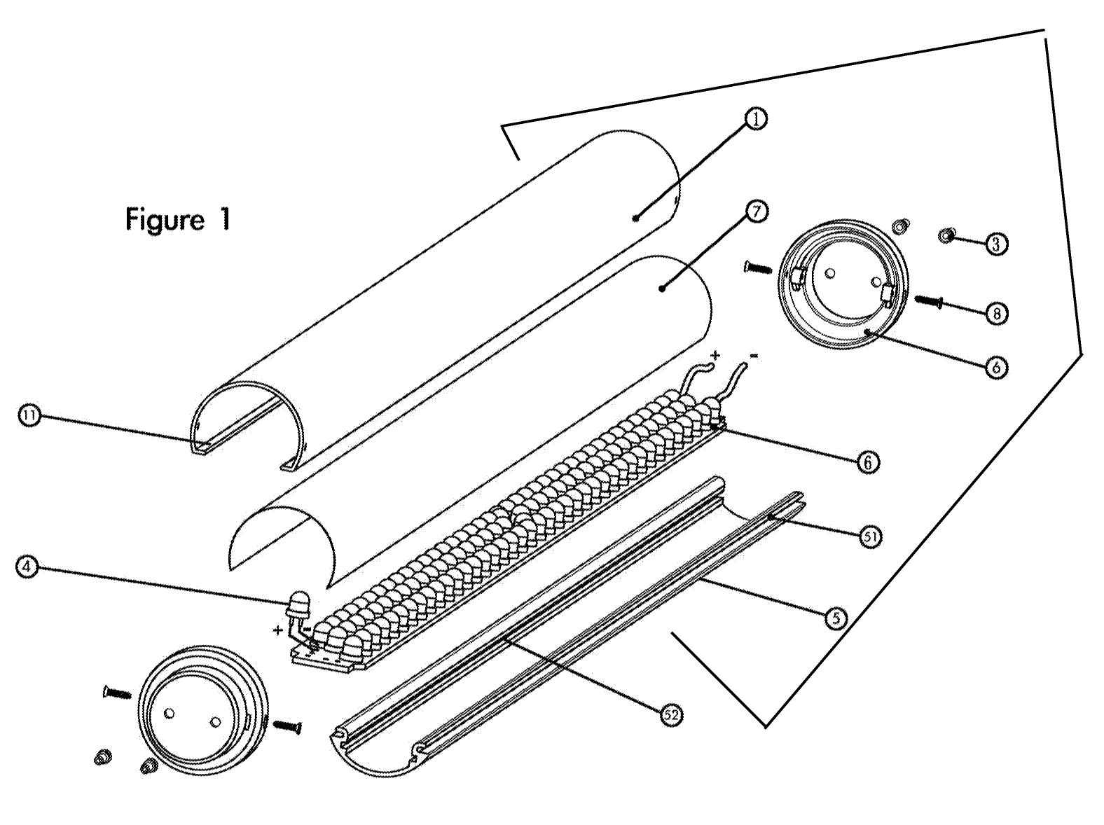

For example, FIG. 1 shows how the LED light tube structure includes a transparent plastic housing (1), LEDs (4) soldered on the metal PCB (2) and connector pins (3). The PCB is connected to the connector pins (3) with two wires. Together with the heat sink, the PCB forms a circular tube. The transparent plastic housing has a separate element, the nano-protection coating (7). On the metal heat sink, there are indentation edges (51), together with rail edges (11) of the plastic housing, the edges form a perfect circular tube. With the end cap (6), the metal connector pins are assembled on the end cap (6). The inner side of the metal heat sink (5) has a gap (52) to allow the metal PCB to be inserted into the metal heat sink (5). The metal PCB layout (2) is to for a rhombus pattern (4 LEDs in one group) to form a unique arrangement to get a high lumen output compared to distributing the LEDs evenly on the metal PCB. The LED driver will connect the lamp holder (3) on the end cap (6) to light up the tube.

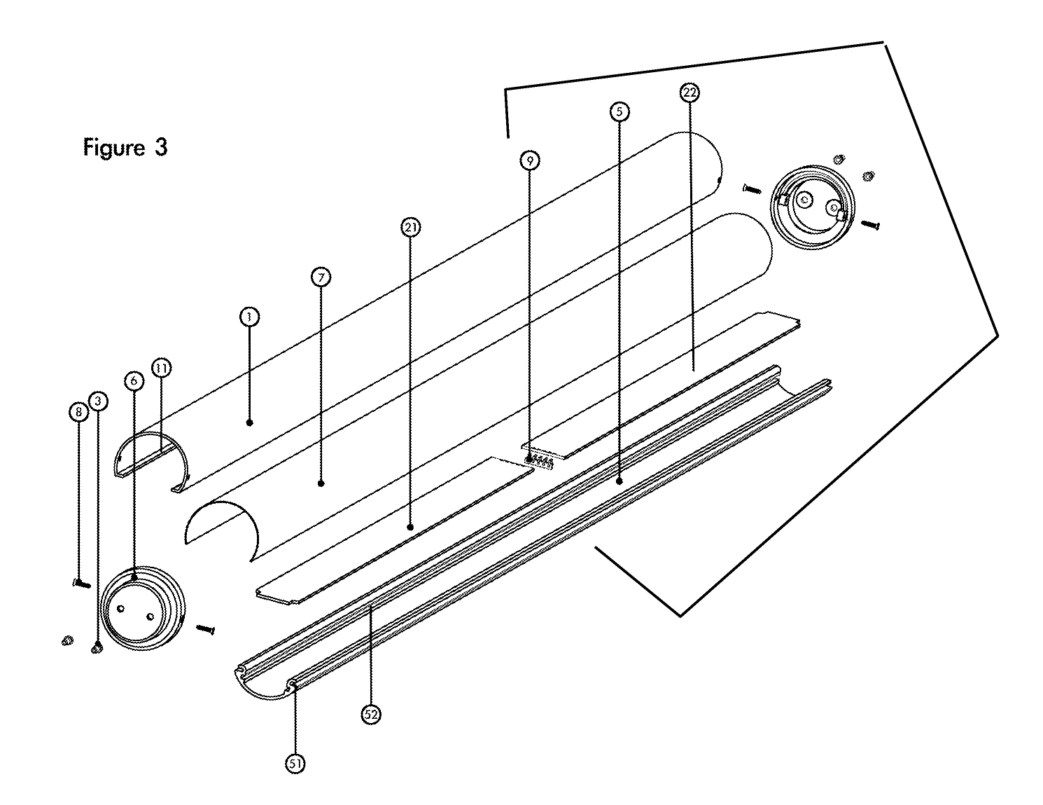

In FIG. 3, there is another embodiment with more than 1 metal PCB (2) to form a complete circuit to join PCB (21) and PCB (22) together. In between PCB (21) and PCB (22) are connector pins (9). As the connector pins are also inserted on to both PCB (21) & (22) to join two circuits together, the structure will provide flexibility to make any length of LED light tubes. The Rhombus pattern can be applied to form the unique arrangement of the present invention to using the same numbers of LEDs, while achieving a higher lumen output. The invention also allow use of different colours of LEDs on the same PCB (2).

In the present invention, the LED light tube:
1) can be installed on any kind of T8, T12 Fixtures or without the fixture;
2) is truly long lasting; and
3) is 100% green to the environment.

As this new development combines low power LEDs and an optical device class plastic tube, LEDs are assembled on the printed circuit board with two wires connecting with the end cap one side only. The LED driver will act as an AC to DC converter plus constant current controller and will supply low DC voltage and current to the LED tube. The printed circuit board will be inserted into the aluminum heat sink. So, the LED light tube will not need the existing ballast and start as compared to fluorescent lighting.

On the three quarters of the circular plastic tube, optical class of plastic with the highest transparency is used, and it is shatter-proof. It will help to reduce the protection package and last much longer.

In order to achieve the best thermal management for the LEDs, the PCB used is a metal PCB. Most of the PCB is a surface mount type. There is a special insertion type metal PCB to allow the cathode and anode of the LED to insert into the metal PCB and to be soldered on an opposite side of the LED-like photo 1. With this special type PCB, extra surface area closely attach to the metal PCB without causing any short circuit to the metal PCB, having the maximum heat transfer directly to the metal PCB. The aluminum heat will act as a high temperature gradient to dissipate the extra heat from the metal PCB to the heat sink. With the present invention, the LED heat extraction is very efficient, thus it will decrease light depreciation rate. In a traditional low power LED, there is no increase in light depreciation period from the first 500 hrs to 3000 hrs, which is better than fluorescent lighting. The LED light tube of the present invention lasts at least 3500 hrs with 70% light maintenance.

Furthermore, the present invention has an LED array arrangement on the metal PCB. The LED pattern is constructed like two arrows pointing at each other. With the present invention, the arrangement achieves a higher lumen output than distribution of the LED evenly through out the metal PCB.

The LED is a very intense light source, and it will hurt eyes, if looked at directly. A piece of nano-material coating is added on the inner side of the LED light tube. The coating can diffuse the light from the LED to make it softer and gentle to eyes. It will hurt eyes, if looked at directly.

This invention has the following advantages:

1) The LED driver is a universal AC voltage input between 85 VAC-265 VAC, producing power output between 6 W-18 W. The overall saving against fluorescent up to 70%.

2) Long life—LED plus excellent thermal management using aluminum PCB together with anodized heat sink extracts heat from the LED effectively.

3) Most of the parts can be recycle with help to reduce waste to the environment

4) Easy to install on any lighting fixture, and it is working under low voltage DC—much safer than high voltage AC.

1. A light emitting diode (LED) lighting-device for an alternative general lighting, the device being circular or tubular, the device comprising:
a metal core printed circuit board having a plurality of LEDs, wherein density of LEDs from a center of the circuit board decreases towards ends thereof, the metal core printed circuit board having one end engaging a DC electrical input.

2. The lighting device of claim 1, further comprising:
a transparent plastic housing; and
a curved metal heat sink made integral with the plastic housing, forming a circuit tube or rectangular rod, the metal core printed circuit board being in heat conductive connection with the metal heat sink.

3. The lighting device of claim 1, wherein said plurality of LEDs are mounted on the circuit board without any current limiting resistor.

4. The lighting device of claim 2, the circuit board being mounted or embedded into the metal heat sink.

5. The lighting device of claim 2, further comprising:
a secondary metal core printed circuit board;
a transparent housing; and
a secondary metal heat sink.

6. The lighting device of claim 2, wherein the metal heat sink has protective oxide layer, if installed onto a high voltage AC fluorescent fixture.

7. The lighting device of claim 1, being connected to an electronics device to convert AC to DC plus providing constant current.

8. The lighting device of claim 1, wherein the LEDs have an array arrangement connecting in a mixture of series and parallel.

9. The lighting device of claim 5, wherein the transparent plastic housing has a nano-optics material coating on the inner side.

10. The lighting device of claim 1, said LEDs having a driver with a step down output in series or parallel connection.
